(19) United States
(12) Patent Application Publication
(10) Pub. No.: US 2020/0003664 A1
(43) Pub. Date: Jan. 2, 2020

(54) Heat And Drip Resistant Testing Sample Holder

(71) Applicant: Daniel Banayan, Encino, CA (US)

(72) Inventor: Daniel Banayan, Encino, CA (US)

(21) Appl. No.: 16/022,423

(22) Filed: Jun. 28, 2018

(51) Int. Cl. G01N 1/28

(52) U.S. Cl. CPC G01N 1/2813

(57) ABSTRACT

A heat and drip resistant testing sample holder (HDRTSH) that is used in tests for determining concentration of various components of a sample. The HDRTSH comprises a substantially flat fibrous testing sheet that is secured to a substantially flat metal sheet by a coupling means, which preferably consists of crimping the two sheets together. A sample is placed on the HDRTSH for testing. The HDRTSH prevents dripping from the fibrous sheet and provides improved heat transfer over other sample holders. The coupling means creates a template for controlling a sample's size and position on a sample testing device. The HDRTSH can be utilized in temperatures up to 1200° C. and is especially appropriate for process control and quality control testing.

### TECHNICAL FIELD

The invention generally pertains to containers for various types of tests, and more particularly to an integrated disposable testing sample holder consisting of a fibrous testing sheet secured to a metal sheet.

### BACKGROUND ART

Product testing has long been a useful and necessary process in many industries during manufacturing and in R&D for quality and process control. From the early days of trial and error to modern industrialized formats utilizing elaborate testing instruments and algorithms, testing has become an essential part of the scientific process for quality control and manufacturing optimization.

Fibrous testing materials, metal trays, and ceramic crucibles are commonly used as testing sample holders for various tests, measurements, and chemical/physical reactions. However, each of these choices has its own limitations. Fibrous testing material, comprised of glass fiber or other materials, is porous and liquid samples can drip through the material, affecting the test result and possibly damaging the test instruments. Conventional, reusable ceramic and aluminum test containers are expensive and hence not considered a disposable item, and continuous labor intense cleaning is typically required to maintain their integrity. Improper cleaning can contribute to contamination and resulting inaccuracy in the test results. These types of non-disposable containers can also leave a residue from the previous test and therefore cause inaccuracy in the test results. Additionally, ceramic containers can easily crack or break. Correspondingly, metal trays can warp, causing uneven heating that affects the test result and the high temperature of the metal can create safety issues. The warping of a testing sample holder during the heating process may cause machinery to short-circuit in a hot/dry air flow, creating uneven heating that can result in test error or damage to the machinery.

With the more efficient approach to testing that has been established through the industrialized format there is now a great need for a more efficient, cost effective, and disposable sample holder to minimize sample holder cleaning, and to minimize test error due to contamination from a previous test performed in the container.

A search of the prior art did not disclose any literature or patents that read directly on the claims of the instant invention. However, the following U.S. patents are considered related:

| | PAT. NO. | INVENTOR | ISSUED |
|---|---|---|---|
| Applica. No. | 14/864,559 | Banayan | 24 Sept 2015 File Date |
| | 2,170,040 | Stuart | 22 Aug. 1939 |
| | 2012/0169354 | Erbe et al | 16 Aug. 2010 |
| | 2010/0238950 | Al-Ghamdi et al | 19 Mar. 2009 |

The application Ser. No. 14/864,559 discloses a heat and resistant resting sample holder (HDRTSH) that is used in tests for determining concentration of various components of a sample. The HDRTSH comprises a substantially flat fibrous testing sheet that is secured to a substantially flat metal sheet by a coupling means, which preferably consists of crimping the two sheets together. A sample is placed on the HDRTSH for testing. The HDRTSH prevent dripping from the fibrous sheet and provides improved heat transfer over other sample holders. The HDRTDH can be utilized in temperatures up to 1200° C. and is especially appropriate for process control and quality control testing.

The U.S. Pat. No. 2,170,040 patent discloses a baking utensil of laminated construction which is utilized for containing foods during the cooking or baking process. The utensil is resistant to heat, will not absorb moisture or crease, and ha smooth, wrinkle free surfaces. The utensil is either laminated or single layer construction, and includes corrugated side walls and flanges, that reinforce the utensil.

The 2012/0169354 publication discloses a food probe for invading into a food stuff. The food probe comprises an elongated rod made of a non-conductive material, a front portion of the elongated rod is provided for invading into the food stuff, a first electrode made of a conductive material and arranged at the front portion of the rod and a second electrode made of a conductive material and arranged at the front portion of the rod at a predetermined distance form the first electrode. A voltage can be applied between the first electrode and the second electrode so that an electrical field is generated.

The 2010/0238950 publication discloses a device for testing food quality and measuring the state of decay of a piece of food based upon measured electrical potential. The device includes a needle probe having an outer cylindrical shell formed from a first metal and a wire mounted coaxially within the outer cylindrical shell. A measuring device for electrical potential, such as a voltmeter, is further provided and is in communication with the needle probe. The device forms a galvanic cell when the probe is inserted into the food, the cell potential decreasing as a function of time in a manner corresponding to the state of decay of the piece of the food.

### DISCLOSURE OF THE INVENTION

In its basic design, the heat and drip resistant testing sample holder (HDRTSH) is comprised of a substantially flat fibrous testing sheet having an upper surface, a lower surface and a perimeter edge; a substantially flat metal sheet also having an upper surface, a lower surface, and a perimeter edge; and coupling means for securing the fibrous testing sheet to the metal sheet. Both the fibrous testing sheet and the metal sheet can be any geometric or non-geometric shape, with circular preferred. Both sheets have equal perimeters.

Although various coupling means can be utilized, the preferred coupling means is crimping by the creation of an inner crimp ring and an outer crimp ring. Once the two crimp rings are created, the fibrous testing sheet is secured to the metal sheet.

For testing, a sample is placed on the fibrous testing sheet, the sample is spread on the sheet while remaining within the diameter of the outer crimp ring, and the HDRTSH 10 with a micro fibrous disc and sample thereon is placed into a testing device. Once the sample has been tested, the HDRTSH and sample are discarded.

In view of the above disclosure, the primary object of the invention is to provide a heat and drip resistant sample testing holder that is convenient, easy to use and economical, and does not have the problems associated with other conventional testing sample holders.

In addition to the primary object, it is also an object of the invention to provide a heat and drip resistant sample testing holder that:
is disposable,
can withstand temperatures up to 1200° C.,
can be used for various samples,
can be stored for extended periods of time,
can be stacked prior to use,
can be made in a variety of sizes and shades,
is easy to manufacture, and
is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a top plan view of the preferred embodiment of the heat and drip resistant testing sample holder (HDRTSH) showing coupling means comprising an outer crimp ring and an inner crimp ring.

FIG. 2 is a cross-sectional view of the preferred embodiment of the HDRSTH taken along the lines 2-2 of FIG. 1.

FIG. 3 is a top plan view of the HDRTSH showing a sample placed thereon.

FIG. 4 is a cross-sectional view of the HDRTSH taken along the lines 4-4 of FIG. 3.

FIG. 5 is a cross-sectional view of the HDRTSH with an additional fibrous testing sheet located above the HDRTSH, prior to being placed thereon.

### BEST MODE FOR CARRYING OUT THE INVENTION

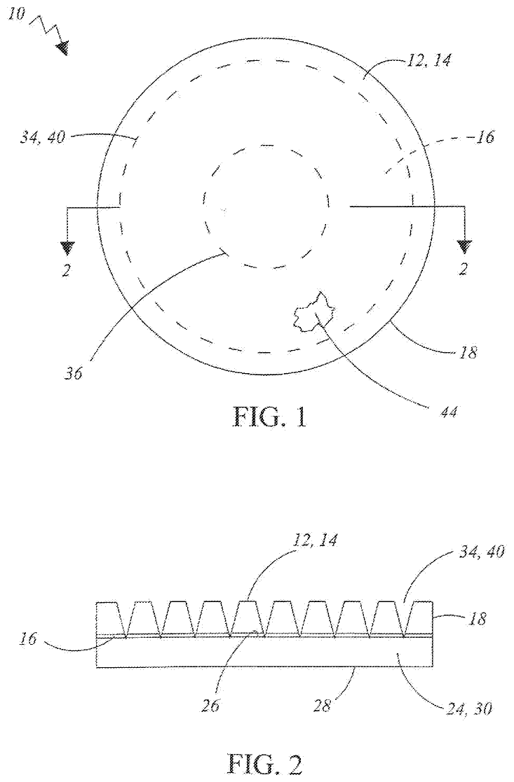

The best mode for carrying out the invention is presented in terms that disclose a preferred and additional embodiments of a heat and drip resistant testing sample holder (HDRTSH 10). The HDRTSH 10 provides a superior alternative to other conventional testing sample holders which include fibrous testing materials, metal trays and ceramic crucibles. The conventional testing sample holders are subject to numerous problems and disadvantages as previously disclosed in the BACKGROUND ART section. The HDRTSH 10, as shown in FIGS. 1-5, offers a solution to the problems and disadvantages by providing an easy to use, efficient and cost effective sample testing holder.

All of the embodiments of the HDRTSH 10 are comprised of the same major elements: a substantially flat fibrous testing sheet 12, a substantially flat metal sheet 24, and coupling means 34.

The fibrous testing sheet 12, as shown in FIGS. 1-5, is comprised of an upper surface 14, a lower surface 16, and a perimeter edge 18. The metal sheet 24, as best shown in FIGS. 2 and 4, is also comprised of an upper surface 26, a lower surface 28, and a perimeter edge 30. The fibrous testing sheet 12 is placed on top of the metal sheet 24 such that the lower surface 16 of the fibrous testing sheet 12 interfaces with the upper surface 26 of the metal sheet 24. The two sheets 12,24 are then secured together by the coupling means 34.

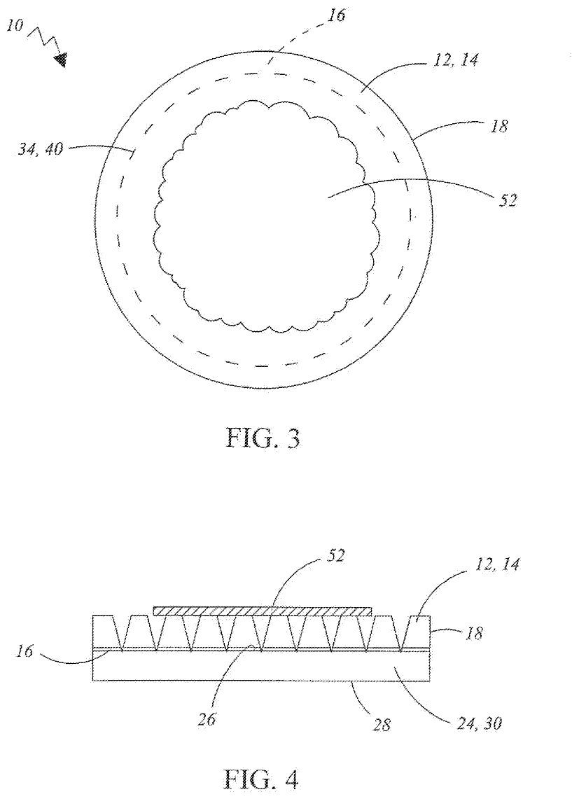

It should be noted that the sample 52, as shown in FIGS. 3 and 4, which is tested, typically comprises a food product. The material of the fibrous testing material is selected from the group consisting of cellulose fibers, quartz fibers, quartz microfibers, borosilicate glass fibers, mixed borosilicate glass and quartz microfibers, and micro glass fibers. Preferably, the material for the fibrous testing material is a micro glass fiber.

The material of the metal sheet 24 is selected from the group of metals consisting of aluminum, tin, lead, titanium, chromium, iron, steel, nickel, copper, zinc, silver, tungsten, platinum and gold. Preferably, the material of the metal sheet is aluminum. The thickness of the metal sheet is determined by the testing parameters, and is typically between 0.01 mm and 0.15 mm. Preferably, the thickness ranges between 0.03 nm and 0.08 mm.

The final geometrical shape of the HDRTSH 10 substrate is determined by the coupling method and the materials used in creating the substrate. The dimensions of the HDRTSH 10 are determined by the size needs of the testing apparatus, which ranges from 22 mm to 200 mm in diameter, and is preferably between 50 mm and 150 mm. Although the HDRTSH 10 is generally circular in design, other geometric or non-geometric shapes may also be produced to correspond with the appropriate testing apparatuses and their needs. Thus, testing samples holders of square, hexagonal, or rectangular shapes may be produced, in addition to any other shapes required.

The proposed materials and coupling method results in a disposable flat substrate testing sample holder that retains its flat shape throughout the heating and cooling process necessitated by a test and testing apparatus. Currently, disposable type aluminum testing pans that are commonly used are packaged by nesting tapered pans inside of each other for easy transportation and distribution. While trying to separate one testing pan from a nested stack, a user can mistakenly take two pans instead of one, hence increasing the consumables cost of the test and decreasing the efficiency of the test. The HDRTSH 10 allows for stacking, not nesting, the testing sample holders atop one another, thereby minimizing the possibility of removing multiple units, decreasing costs, and increasing testing efficiency.

In the preferred embodiment of the HDRTSH 10, the coupling means 34 is comprised of crimping the two sheets 12,24 together. As shown in FIG. 1, an inner crimp ring 36 is created near the substantial center, and an outer crimp ring 40 is created substantially adjacent the perimeter edge 18. The two crimp rings 36,40 have proven to be an effective means of securing the two sheets 12,24 together during production, and maintaining the sheets together both in storage prior to use, and during use. Other coupling means can also be utilized including an adhesive 44, as shown in FIG. 1, laser fusion thermal fusion, ultrasonic fusion or other suitable methods. When an adhesive 44 is used, the adhesive is a high temperature adhesive such as a high temperature ceramic cement, which can be used in temperatures up to 3000° C.

The coupling methods for the HDRTSH 10 created a flat testing sample holder instead of the traditional bowl shaped consumables and testing containers previously used. This flattened shape is an ideal configuration for many quality control testing apparatuses. The thin and flat nature of the consumable testing sample holder lends to more uniform heating across the substrate. Further, the geometrical shape of the HDRTSH 10 creates a template for a uniform spreading of a sample and produces faster drying time due to more uniform heating, when compared to the use of traditional round aluminum pans as testing substrates. The template is meant to control a sample size and location, leading to greater consistency.

In addition to the advantage of the ability of the HDRTSH 10 to be used in high temperature settings up to 1200° C. the testing sample holder's combination of a fibrous testing material, ideally of a glass fiber material, coupled with a metal sheet has several other advantages. The use of a metal liner coupled with a glass fiber fibrous testing material is designed to prevent parts of the sample from dripping through the fibrous testing material and onto the testing apparatus. The porous nature of fibrous testing material allows materials to pass through or be absorbed by the fibrous testing material, which proves to be a problem in many situations. Previously, this was remedied by the addition of a metal or ceramic tray under the fibrous testing material but when the HDRTSH's 10 two materials are coupled together they create a superior sample holder. The combination of the fibrous testing material coupled with the metal sheet decreases costs, increases efficiency, and leads to a more streamlined approach to testing.

Further, since a user can not remove the glass fiber material and reuse the dish for a subsequent test the overall test results will improve. Residue from a previous test sample will not affect subsequent test results, as a new testing sample holder is used for each test. This also allows for multiple samples to be prepared concurrently, thereby decreasing the preparation time required to run multiple samples on a given testing apparatus. Further, since the HDRTSH 10 is more efficient in its use of materials, the disposability of the sample holder is increased.

The HDRTSH 10 also creates a more environmentally friendly testing sample holder. The amount of material needed for the HDRTSH 10 is a substantially less than a conventional metal tray and fibrous testing material combination, generating a smaller impact on the environment while maintaining a high level of cost effectiveness and disposability. The lack of significant weight while retaining structural integrity is a preferred object of the HDRTSH 10. Furthermore, the lightweight nature of the HDRTSH 10 allows for faster cooling, which results in time saved in cooling the test sample and leads to a faster turnaround for the next test.

In order to use the HDRTSH 10, the following steps are performed:

1. Place a single HDRTSH 10 on top of an equally perimetered micro fibrous disc.

2. Place the HDRTSH 10 and disc on a balance pan of a food product testing device.

3. Press tare key to tare the total weight.

4. Place a sample 52 to be tested on the fibrous testing sheet 12.

5. Weigh the sample 52.

6. Remove the HDRTSH 10 and sample thereon from the balance pan.

7. Using a spreading tool, spread the sample 52 evenly on the fibrous testing sheet 12, insuring that no fiber is removed from the sheet and the sample 52 remains within the diameter of the outer crimp ring or between the two folded sections.

8. Remove the micro fibrous disc from the balance pan.

9. Place the micro fibrous disc on top of the sample 52 upon the HDRTSH 10.

10. Apply downward pressure to the micro fibrous disc to insure adhesion.

11. Place the HDRTSH 10 with the sample 52 and micro fibrous disc on the balance pan.

12. Push the start key on the testing device to commence the test.

13. Review test results.

14. Remove HDRTSH 10 with sample and micro fibrous disc from balance pan.

15. Dispose of the HDRTSH 10, sample and micro fibrous.

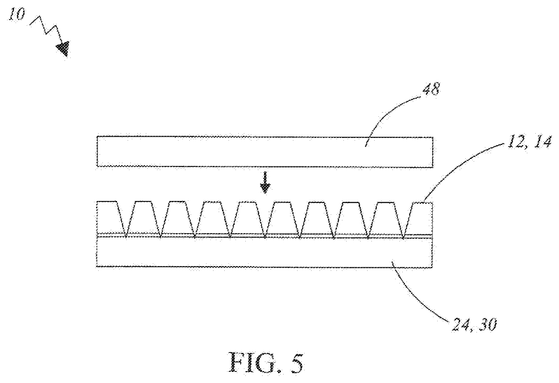

In another embodiment of the HDRSTH 10, as shown in FIG. 5, a second fibrous testing sheet 48 of equal size, shape and material to the first fibrous testing sheet 12 is placed on top but not coupled to the testing sample holder, covering a sample placed thereon.

1. A heat and drip resistant testing sample holder that is utilized during a test to determine concentration of components of a sample, the testing sample holder comprised of a substantially flat fibrous testing sheet that is coupled to a substantially flat metal sheet.

2. The heat and drip resistant testing sample holder of claim 1 wherein the sample is a food product and is tested for oil, fat, solid, and aqueous components.

3. The heat and drip resistant testing sample holder of claim 1 wherein the fibrous testing sheet is made of a material selected from the group consisting of cellulose fibers, quartz fibers, borosilicate glass fibers, and micro glass fibers.

4. The heat and drip resistant testing sample holder of claim 1 wherein the metal sheet is made of a material selected from the group consisting of aluminum, tin, lead, titanium, chromium, iron, steel, nickel, copper, zinc, silver, tungsten, platinum and gold.

5. The heat and drip resistant testing sample holder of claim 1 wherein the coupling means is comprised of crimping.

6. The heat and drip resistant testing sample holder of claim 1 wherein the coupling means is comprised of an adhesive.

7. The heat and drip resistant testing sample holder of claim 1 wherein the testing sample holder is disposable.

8. The heat and drip resistant testing sample holder of claim 1 further comprising a second fibrous testing sheet with the same dimensions as the first sheet, wherein the second sheet is placed on top of a sample located on the first sheet.

9. A heat and drip resistant testing sample holder that is utilized during a test to determine concentration of components of a sample, the testing sample holder comprised of
a substantially flat fibrous testing sheet having:
an upper surface,
a lower surface,
and a perimeter edge,
a substantially flat metal sheet having:
an upper surface,
a lower surface,
and a perimeter edge;
coupling means for securing the fibrous testing sheet to the metal sheet, the coupling means comprising:
an inner crimp ring, and
an outer crimp ring

10. The heat and drip resistant testing sample holder of claim 9 wherein the sample is a food product.

11. The heat and drip resistant testing sample holder of claim 9 wherein the fibrous testing sheet is made of a material selected from the group consisting of cellulose fibers, quartz fibers, borosilicate glass fibers, and micro glass fibers.

12. The heat and drip resistant testing sample holder of claim 9 wherein the metal sheet is made of a material selected from the group consisting of aluminum, tin, lead, titanium, chromium, iron, steel, nickel, copper, zinc, silver, tungsten, platinum and gold.

13. The heat and drip resistant testing sample holder of claim 9 wherein the fibrous testing sheet and the metal sheet have equal perimeters that range from 5 cm to 15 cm.

14. The heat and drip resistant testing sample holder of claim 9 wherein the fibrous testing sheet is placed on top of the metal sheet such that the lower surface of the fibrous testing sheet interfaces with the upper surface of the metal sheet.

15. The heat and drip resistant testing sample holder of claim 9 wherein a sample is placed on the upper surface of the fibrous testing sheet, and the sample is maintained within an area not exceeding the outer crimp ring.

16. A heat and drip resistant testing sample holder that is utilized during a test to determine concentration of components of a sample, the testing sample holder comprised of
a substantially flat fibrous testing sheet having:
an upper surface,
a lower surface,
and a perimeter edge,
a substantially flat metal sheet having:
an upper surface,
a lower surface, and a perimeter edge; and
coupling means comprising an adhesive that is placed between the fibrous testing sheet lower surface and the metal sheet upper surface.

17. The heat and drip resistant testing sample holder of claim 16 wherein the sample is a food product.

18. The heat and drip resistant testing sample holder of claim 16 wherein the adhesive is a high temperature adhesive.

19. The heat and drip resistant testing sample holder of claim 16 wherein the fibrous testing sheet is made of a material selected from the group consisting of cellulose fibers, quartz fibers, borosilicate glass fibers, and micro glass fibers.

20. The heat and drip resistant testing sample holder of claim 16 wherein the metal sheet is made of a material selected from the group consisting of aluminum, tin, lead, titanium, chromium, iron, steel, nickel, copper, zinc, silver, tungsten, platinum and gold.
